(19) United States
(12) Patent Application Publication
(10) Pub. No.: US 2025/0375969 A1
(43) Pub. Date: Dec. 11, 2025

(54) PRINTING DEVICE AND PRINTING METHOD

(71) Applicant: SEIKO EPSON CORPORATION, Tokyo (JP)

(72) Inventor: Takamitsu KONDO, Azumino-shi (JP)

(21) Appl. No.: 19/228,010

(22) Filed: Jun. 4, 2025

(30) Foreign Application Priority Data
Jun. 5, 2024 (JP) 2024-091313

(51) Int. Cl. B41J 3/407; B41J 2/21; B41J 11/00; C09D 11/101; C09D 11/40; D06P 5/30

(52) U.S. Cl. CPC B41J 3/4078; B41J 2/2114; B41J 11/008; C09D 11/101; C09D 11/40; D06P 5/30

(57) ABSTRACT

The printing device 1 includes a head unit U having a nozzle row L formed of a plurality of nozzles 21 capable of ejecting the first liquid onto the medium S, and a control unit 4 that controls the ejection operation of the head unit U. The first liquid is a colorless liquid containing resin particles and water. In a case where the medium S is a fabric having an uneven shape in which fibers in different directions intersect each other, the control unit 4 can execute a jacquard print mode in which an image is formed on the medium S by ejecting the first liquid from the nozzle row L.

The present application is based on, and claims priority from JP Application Serial Number 2024-091313, filed Jun. 5, 2024, the disclosure of which is hereby incorporated by reference herein in its entirety.

### BACKGROUND

### 1. Technical Field

The present disclosure relates to a printing device and a printing method.

### 2. Related Art

In JP-A-2012-87422, a printing method using dyes on fabric made of synthetic fibers is disclosed. This method involves a step of inkjet printing transparent patterns on the fabric using UV ink with transparency, and a dyeing step of dyeing the entire fabric with dye, thereby forming patterns with different contrasts on the fabric.

When a transparent pattern is inkjet printed with a dyeable UV ink on a fabric using synthetic fibers and then the entire fabric is dyed with a dye using the above-described textile printing method, a diffuse reflection section obtained by combining reflections from individual fibers of the synthetic fibers used as the fabric looks whitish, whereas a surface printed with the transparent UV ink looks dark due to suppressed diffuse reflection from the individual fibers, whereby a pattern can be formed with a shading of a single color.

Jacquard weaving is known as a fabric in which the pattern is realized by changing the way of weaving in accordance with the pattern. Jacquard weaving has a partially different gloss feeling depending on the pattern, and the pattern appears to emerge, so that the design property is high, and a high-grade feeling is also recognized. However, since the jacquard weaving requires changing the way of weaving in accordance with the pattern, the productivity is poor, the amount of thread used is large, and it is necessary to prepare patterned paper, which inevitably leads to a high cost. There is a problem that it is difficult to express a complicated pattern in the jacquard weave.

In the configuration of JP-A-2012-87422, since UV ink is used with respect to the fabric, the UV ink that has penetrated into the fabric may remain without being cured even by UV irradiation. In this case, there is a problem that the uncured UV ink emits a strong odor. According to JP-A-2012-87422, a pattern cannot be formed on a fabric only by inkjet printing a transparent pattern using a UV ink, and the pattern is formed for the first time by dyeing the entire fabric with the dye after printing with the UV ink. Therefore, an image effect similar to a jacquard weave, which is based on the premise that dyeing is not performed, cannot be obtained.

### SUMMARY

A printing device includes
a print head unit with a first nozzle group that has a plurality of nozzles and that ejects a first liquid onto a medium and
a control section configured to control an ejection operation of the print head unit; wherein
the first liquid is colorless liquid containing resin particles and water and
the control section is configured to, when the medium is fabric having an uneven shape in which fibers in different directions intersect each other, execute a first print mode in which an image is formed on the medium by ejecting the first liquid from the first nozzle group.

A printing method using a printing device including a print head unit having a first nozzle group including a plurality of nozzles capable of ejecting a first liquid, which is a colorless liquid containing resin particles and water to a medium, the printing method including
when the medium is a fabric having an uneven shape in which fibers in different directions intersect, using a computer to execute a first print mode in which the first liquid is ejected from the first nozzle group to form an image on the medium.

### BRIEF DESCRIPTION OF THE DRAWINGS

FIG. 1 is a schematic configuration diagram of a printing device.

FIG. 2 is an exploded perspective view of the head unit.

FIG. 3 is a bottom view of the head unit.

FIG. 4 shows an example of a print product.

FIG. 5 is a control flow of the printing device.

FIG. 6 is a control flow of the printing device.

FIG. 7 shows an example of the warning screen.

### DESCRIPTION OF EMBODIMENTS

Hereinafter, the present disclosure will be described through embodiments of the disclosure, but the disclosure according to the claims is not limited to the following embodiments. All of the configurations described in the embodiments are not necessarily essential as means for solving the problems. For clarification of the description, the following description and drawings are appropriately omitted and simplified. In the drawings, the same elements are denoted by the same reference numerals, and redundant description thereof will be omitted as appropriate.

In each drawing, X, Y, and Z represent three spatial axes orthogonal to each other. In this specification, directions along these axes are referred to as an X direction, a Y direction, and a Z direction. In the drawings, an arrow indicates the positive direction “+” and the opposite direction is negative “−”. Directions of three spatial axes that do not limit the positive direction, and the negative direction will be described as an X-axis direction, a Y-axis direction, and a Z-axis direction.

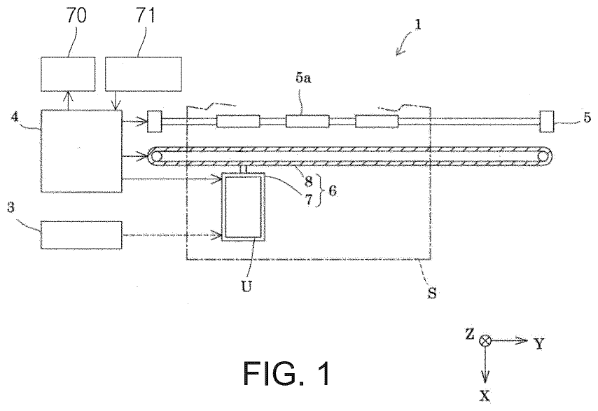

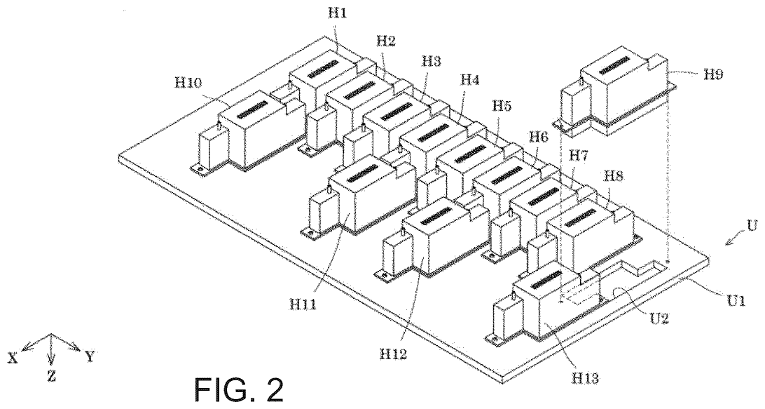

As illustrated in FIGS. 1 and 2, a printing device 1 is a so-called serial-type digital textile printing machine which includes a head unit U having a plurality of liquid ejection heads H, and performs printing by ejecting liquid in a +Z direction from the liquid ejection heads H toward a medium S while transporting the medium S in an X-axis direction and reciprocating the head unit U in a Y-axis direction. The head unit U is a specific example of a print head unit. As the medium S, an arbitrary material such as fabric, recording sheet, or a resin film can be used. The fabric is not particularly limited. Materials constituting the fabric are not particularly limited. Examples include natural fibers such as cotton, hemp, wool, and silk; synthetic fibers such as polypropylene, polyester, acetate, triacetate, polyamide, and polyurethane; and biodegradable fibers such as polylactic acid. Mixed fibers of these materials may also be used. The fabric may be woven fabric, knitted fabric, nonwoven fabric, or the like of the above-mentioned fibers, or may be mixed fabric or the like. The liquids which is ejected from the printing device 1 are colored inks which includes coloring materials, reaction liquids containing coagulant agents to coagulate colored inks, treatment liquid containing softening agents, overcoat liquids, or the like. The colored ink is a specific example of a second liquid and a colored liquid. The overcoat liquid is a specific example of a first liquid and a colorless liquid. The colored ink is a colored liquid containing coloring materials such as dyes and pigments. Examples of the pigment used in the coloring materials includes inorganic pigments such as carbon used in black inks, titanium oxide used in white inks, and alumina used in silver metallic inks.

After the reaction liquid is ejected onto the medium S, by ejecting the colored ink to the position where the reaction liquid lands on the medium S, the reaction liquid and the colored ink mix on the medium S or at the position where the reaction liquid penetrates into the medium S, and the colored ink is aggregated by the reaction liquid, whereby the fixability of the colored ink to the medium S can be improved. The reaction liquid is liquid containing a coagulant agent that coagulates the colored ink. An organic acid may be included as a coagulant agent to coagulant the coloring material. As the reaction liquid containing organic acid, reaction liquid containing at least glutaric acid, solvent, and activator can be adopted, and reaction liquid containing organic acids such as citric acid, malic acid, or malonic acid can also be used.

The overcoat liquid is typically one that covers the colored ink containing the coloring material that landed on the medium S, does not contain the coloring material, and improves the fixability of the colored ink ejected onto the medium S. In the present embodiment, as will be described later, in a case where the medium S is a fabric, sometimes an image is formed on the medium S by using only an overcoat liquid that is a colorless liquid without using colored ink. The composition of the overcoat liquid will be described in detail at the end of the specification.

The treatment liquid is one containing a softening agent that imparts flexibility to the medium S. The treatment liquid is, for example, silicone oil containing dimethyl silicone, amino-modified silicone (weak anion), or ether silicone as a main component. As another example, the treatment liquid may be one containing any one of a cationic surfactants and polyester (nonionic) as a main component. By applying the softening agent, it is possible to improve the flexibility, water resistance, and coloring properties of the medium S.

The printing device 1 includes a head unit U, a liquid storage section 3, a control unit 4 which is a control section, a transport mechanism 5 which transports the medium S, a movement mechanism 6, a display 70, and a touch panel 71. The display 70 is a specific example of a display means. The touch panel 71 is a specific example of an input means. The display 70 and the touch panel 71 are typically arranged to overlap each other.

As shown in FIG. 2, the head unit U includes a plurality of liquid ejection heads H and a support member U1 that supports the plurality of liquid ejection heads H. Each of the liquid ejection heads H ejects liquid supplied from the liquid storage section 3 in the +Z direction as droplets. The liquid storage section 3 individually stores a plurality of types of liquids having different colors and components which are ejected from the liquid ejection head H.

The control unit 4 includes, for example, a control device such as a central processing unit (CPU) or a field programmable gate array (FPGA), and a storage device such as a semiconductor memory. The control unit 4 is electrically coupled to the liquid ejection head H via external wiring (not shown). The control unit 4 integrally controls each element of the printing device 1, that is, the liquid ejection head H, the transport mechanism 5, the movement mechanism 6, and the like, typically according to print image data acquired from an external device such as a personal computer.

The transport mechanism 5 transports the medium S in the X-axis direction and includes a transport roller 5a. That is, the transport mechanism 5 transports the medium S in the X-axis direction by the rotation of the transport roller 5a. The transport roller 5a is rotated by the driving of a transport motor (not shown). The control unit 4 controls the transport of the medium S by controlling the operation of the medium transport motor.

The movement mechanism 6 is a mechanism for reciprocating the head unit U in the Y-axis direction and includes a holding body 7 and a transport belt 8. The holding body 7 is a so-called carriage that holds the head unit U and is fixed to the transport belt 8. The transport belt 8 is an endless belt installed along the Y-axis direction. The transport belt 8 is rotated by the drive of a transport motor (not shown). The control unit 4 rotates the transport belt 8 by controlling the driving of the transport motor and causes the head unit U to reciprocate in the Y-axis direction together with the holding body 7.

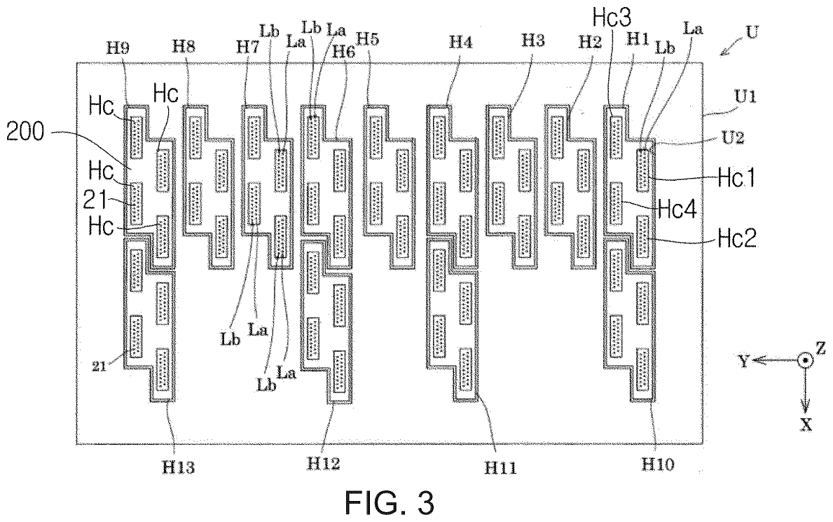

The plurality of liquid ejection heads H mounted on the head unit U perform the ejection operation of ejecting the liquid, in the +Z direction, supplied from the liquid storage section 3 as droplets from each of nozzles 21 (see FIG. 3) under the control of the control unit 4. The ejection operation by the liquid ejection head H is performed in parallel with the transport of the medium S by the transport mechanism 5 and the reciprocating movement of the liquid ejection head H by the movement mechanism 6, and thus so-called printing in which liquid is applied to the medium S and an image is formed on the medium S is performed.

The print processing method includes two modes of a bidirectional printing method and a unidirectional printing method. Hereinafter, moving the head unit U once in the Y-axis direction is referred to as a single pass (abbreviated as one pass). The period of one pass is a period required for moving the head unit U once in the Y-axis direction.

In the bidirectional printing method, the printing device 1 performs a +Y direction printing process by moving the head unit U in the +Y direction while ejecting liquid to form a partial image corresponding to the bandwidth of the first pass on the medium S. Next, the printing device 1 executes a movement process of moving the medium S by the band width in the X-axis direction and executes a −Y direction printing process of forming a band-width partial image corresponding to the second pass on the medium S by ejecting liquid while moving the head unit U in the −Y direction. Thereafter, the printing device 1 repeats the +Y direction printing process and the −Y direction printing process until an image is formed on the medium S. In the bidirectional printing method, the movement process may be performed after the +Y direction printing process and the −Y direction printing process are performed, or the movement process may be performed after each of the +Y direction printing process and the −Y direction printing process is performed a plurality of times. The bidirectional printing method can shorten the time required until an image is formed on the medium S compared to the unidirectional printing method. In the bidirectional printing method, so-called landing adjustment for managing the positional relationship between the landing position of the liquid in the forward path in the Y direction and the landing position of the liquid in the return path in the Y direction is required. For the landing adjustment, the control unit 4 forms a test pattern image on the medium S with the colored ink in the forward path in the Y direction, and the control unit 4 forms a test pattern image on the medium S with the colored ink in the return path in the Y direction. The test pattern image of the forward path and the test pattern image of the return path may be the same or different. The control unit 4 detects the test pattern image of the forward path and the test pattern image of the return path formed on the medium S and adjusts the ejection timing in the forward path in the Y direction and the ejection timing in the return path in the Y direction based on the detection result. The detection device used for detection is typically an imaging device.

The +Y direction printing process described above is executed by the unidirectional printing method. Next, the printing device 1 performs a movement process of moving the medium S in the X-axis direction by the bandwidth. Thereafter, the printing device 1 repeats the +Y direction printing process and the moving process until an image is formed on the medium S. In the unidirectional printing method, the movement process may be performed after the +Y direction printing process is performed a plurality of times.

FIG. 2 is an exploded perspective view of the head unit U according to the present embodiment. FIG. 3 is a schematic view of the head unit U as viewed in the −Z direction. In addition, each direction of the head unit U will be described based on directions when the head unit U is mounted on the printing device 1, that is, the X-axis direction, the Y-axis direction, and the Z-axis direction.

As shown in the drawing, the head unit U includes a plurality of liquid ejection heads H and a support member U1 which supports the plurality of liquid ejection heads H in common. The liquid ejection head H is a specific example of a head.

The support member U1 is formed of a plate-shaped member made of a metallic material or a resinous material, and is provided with a plurality of mounting holes U2 for supporting the liquid ejection head H. The liquid ejection heads H are supported by the support member U1 in a state of being inserted into the mounting holes U2.

As shown in FIG. 3, each liquid ejection head H includes a plurality of head chips Hc and a holder 200.

The plurality of head chips Hc are held by the holder 200.

The plurality of nozzles 21 are formed in each head chip Hc. The plurality of nozzles 21 are arranged in a row along the X-axis direction. The nozzle rows L are provided with the nozzles 21 arranged along the X-axis direction and are provided in two rows spaced apart in the Y-axis direction. In the present embodiment, the two nozzle rows L are referred to in order in the +Y direction as a nozzle row La and a nozzle row Lb. Hereinafter, when the nozzle rows La and Lb are not distinguished from each other, they are referred to as the nozzle rows L.

Four head chips Hc are provided along the X-axis direction with respect to the holder 200. The four head chips Hc are arranged in a staggered manner along the X-axis direction.

In the present embodiment, the liquid ejection heads H are arranged such that a first row of nine liquid ejection heads H arranged along the Y-axis and a second row of four liquid ejection heads H arranged along the Y-axis are arranged in the X-axis direction. In the present embodiment, the nine liquid ejection heads H constituting the first row are referred to as liquid ejection heads H1 to H9 in order in the +Y direction, and the four liquid ejection heads H constituting the second row are referred to as liquid ejection heads H10 to H13 in order in the +Y direction. Hereinafter, when the liquid ejection heads H1 to H13 are not distinguished from each other, they are referred to as a liquid ejection head H.

The nozzle rows La and Lb of the liquid ejection head H5 eject the reaction liquid.

The nozzle rows La and Lb of the liquid ejection heads H4 to H2, which are positioned in the −Y direction with respect to the liquid ejection head H5, and the nozzle row Lb of the liquid ejection head H1, which is positioned at the end section in the −Y direction, eject colored ink, which includes a coloring material. The nozzle row La of the liquid ejection head H1 positioned at the end section in the −Y direction ejects the overcoat liquid.

Specifically, the liquid ejection head H1 includes a head chip Hc1, a head chip Hc2, a head chip Hc3, and a head chip Hc4 as the plurality of head chips Hc. Among these, the nozzle row Lb of the head chip Hc1 is a specific example of the second nozzle group and can eject colored ink, while the nozzle row La of the head chip Hc1 is a specific example of the first nozzle group and can eject the overcoat liquid. The same applies to the head chip Hc2 of the liquid ejection head H1, the head chip Hc3 of the liquid ejection head H1, and the head chip Hc4 of the liquid ejection head H1. That is, the nozzle row La capable of ejecting the colored ink and the nozzle row Lb capable of ejecting the overcoat liquid are accommodated in the same head chip Hc.

The nozzle rows La and Lb of the liquid ejection heads H6 to H8 positioned in the +Y direction with respect to the liquid ejection head H5 and the nozzle row La of the liquid ejection head H9 positioned at the end section in the +Y direction eject colored ink containing a coloring material. The overcoat liquid is ejected from the nozzle row Lb of the liquid ejection head H9 positioned at the end section in the +Y direction.

Here, the liquid ejected from the nozzle rows La and Lb of the liquid ejection heads H4 to H1, positioned in the −Y direction of the liquid ejection head H5, and the liquid ejected from the nozzle rows La and Lb of the liquid ejection heads H6 to H9, positioned in the +Y direction of the liquid ejection head H5, are arranged in the same order towards the +Y direction and the −Y direction with reference to the liquid ejection head H5. That is, the order of the liquid ejected from the nozzle rows La and Lb arranged in the −Y direction from the liquid ejection head H5 is the same as the order of the liquid ejected from the nozzle rows La and Lb arranged in the +Y direction from the liquid ejection head H5.

To be specific, the nozzle row Lb of the liquid ejection head H4 is arranged at the first position in the −Y direction with respect to the liquid ejection head H5, and the nozzle row La of the liquid ejection head H6 is arranged at the first position in the +Y direction. The nozzle row Lb of the liquid ejection head H4 and the nozzle row La of the liquid ejection head H6 eject the same type of ink, that is, black ink, in the present embodiment. The nozzle row La of the liquid ejection head H4 is arranged at the second position in the −Y direction with respect to the liquid ejection head H5, and the nozzle row Lb of the liquid ejection head H6 is arranged at the second position in the +Y direction. The nozzle row La of the liquid ejection head H4 and the nozzle row Lb of the liquid ejection head H6 eject magenta ink. The nozzle row Lb of the liquid ejection head H3 is arranged at the third position in the −Y direction with respect to the liquid ejection head H5, and the nozzle row La of the liquid ejection head H7 is arranged at the third position in the +Y direction. The nozzle row Lb of the liquid ejection head H3 and the nozzle row La of the liquid ejection head H7 eject yellow ink. The nozzle row La of the liquid ejection head H3 is arranged at the fourth position in the −Y direction with respect to the liquid ejection head H5, and the nozzle row Lb of the liquid ejection head H7 is arranged at the fourth position in the +Y direction. The nozzle row La of the liquid ejection head H3 and the nozzle row Lb of the liquid ejection head H7 eject green ink. The nozzle row Lb of the liquid ejection head H2 is arranged at the fifth position in the −Y direction with respect to the liquid ejection head H5, and the nozzle row La of the liquid ejection head H8 is arranged at the fifth position in the +Y direction. The nozzle row Lb of the liquid ejection head H2 and the nozzle row La of the liquid ejection head H8 eject red ink. The nozzle row La of the liquid ejection head H2 is arranged at the sixth position in the −Y direction with respect to the liquid ejection head H5, and the nozzle row Lb of the liquid ejection head H8 is arranged at the sixth position in the +Y direction. The nozzle row La of the liquid ejection head H2 and the nozzle row Lb of the liquid ejection head H8 eject cyan ink. The nozzle row Lb of the liquid ejection head H5 is arranged at the seventh position in the −Y direction with respect to the liquid ejection head H1, and the nozzle row La of the liquid ejection head H9 is arranged at the seventh position in the +Y direction. The nozzle row Lb of the liquid ejection head H1 and the nozzle row La of the liquid ejection head H9 eject the orange ink. The nozzle row La of the liquid ejection head H1 is arranged at the eighth position in the −Y direction with respect to liquid ejection head H5, and the nozzle row Lb of liquid ejection head H9 is arranged at the eighth position in the +Y direction. The nozzle row La of the liquid ejection head H1 and the nozzle row Lb of the liquid ejection head H9 eject the overcoat liquid.

With this configuration, in the plurality of liquid ejection heads H, the nozzle rows L arranged along the Y-axis direction, the nozzle rows L are arranged in the order of black ink, magenta ink, green ink, red ink, cyan ink, orange ink, and overcoat liquid from the liquid ejection head H5 in both the +Y direction and the −Y direction. Further, the two nozzle rows La and Lb of the liquid ejection head H5 eject the reaction liquid. For this reason, even when the head unit U moves in the +Y direction or moves in the −Y direction, the ejection order of the reaction liquid, the colored ink including the coloring material, and the overcoat liquid can be set to the same order.

In the present embodiment, by ejecting the colored ink, the reaction liquid, and the overcoat liquid from the liquid ejection heads H1 to H9 arranged along the Y-axis, it is possible to eject the colored ink, the reaction liquid, and the overcoat liquid in the same pass. Therefore, since it is possible to cause the colored ink and the overcoat liquid to react with the reaction liquid for each pass, it is difficult for bleeding to occur on the medium S.

Here, to specifically explain the printing process in the first row, when executing the +Y direction printing process, after ejecting the reaction liquid from the liquid ejection head H5 onto the medium S, colored ink is ejected onto the medium S in the order of the nozzle rows Lb of the liquid ejection head H4, the liquid ejection head H3, the liquid ejection head H2, and the liquid ejection head H1. Then, the overcoat liquid is ejected onto the medium S from the nozzle row La of the liquid ejection head H1. On the other hand, when the −Y direction printing process is performed, after the reaction liquid is ejected onto the medium S from liquid ejection head H5, the colored ink is ejected onto the medium S in the order of liquid ejection head H6, liquid ejection head H7, liquid ejection head H8, and the nozzle row La of liquid ejection head H9, and then the overcoat liquid is ejected onto the medium S from the nozzle row Lb of liquid ejection head H9. When the printing process in the first row is completed, a moving process of moving the medium S by the bandwidth in the X-axis direction is executed, and the printing process in the second row is executed. In the printing process in the second row, after the overcoat liquid is ejected onto the medium S from the liquid ejection head H10 and H13, the treatment liquid containing the softening agent is ejected onto the medium S from the liquid ejection head H12 and H11.

The control unit 4 can selectively execute the normal print mode and the jacquard print mode. The jacquard print mode is a specific example of the first print mode.

In a case where the normal print mode is executed, the control unit 4 forms an image on the medium S by ejecting the reaction liquid, the colored ink, the overcoat liquid, and the treatment liquid onto the medium S. In short, when the control unit 4 executes the normal print mode, the control unit 4 forms an image on the medium S mainly using the colored ink.

On the other hand, in a case where the jacquard print mode is executed, the control unit 4 forms an image on the medium S by mainly ejecting the overcoat liquid onto the medium S without using the colored ink. At this time, the control unit 4 may or may not eject the reaction liquid or the treatment liquid onto the medium S. Both the reaction liquid and the treatment liquid are specific examples of a colorless liquid. In the present embodiment, when the jacquard print mode is executed, the control unit 4 forms an image on the medium S by ejecting only the overcoat liquid onto the medium S without using the colored ink. The image formed on the medium S in the jacquard print mode is typically an image representing a pattern or a design.

The overcoat liquid is a specific example of a first liquid which is a colorless liquid containing resin particles and water. In other words, the first liquid is not UV curable ink. In other words, it can be said that the first liquid is a liquid containing no photo polymerization initiator. That is, when the control unit 4 executes the jacquard print mode, the UV curable ink containing the photo polymerization initiator is not used.

Here, in a case where the control unit 4 executes the jacquard print mode, the medium S is limited to a fabric having an uneven shape in which fibers in different directions intersect. The fabric having an uneven shape in which fibers in different directions cross each other includes a fabric having an uneven shape in which fibers cross each other. In other words, having an uneven shape in which fibers in different directions intersect with each other means not a nonwoven fabric but a woven fabric or a knitted fabric. Typically, fabric having glossiness. The fact that the fabric having glossiness typically means that light reflection characteristics change depending on the angle at which the fabric is observed. For example, if the fabric is wrinkled such that the fabric is wavy, the peaks of the waves will typically appear white if the illumination in the observation environment is white. In this case, the fabric is said to have glossiness. An example of fabric having glossiness is a fabric woven from a plurality of synthetic fibers. This is because synthetic fibers exhibit a flat surface property as compared with the natural fiber. Examples of synthetic fibers include synthetic fibers such as polypropylene, polyester, acetate, triacetate, polyamide, and polyurethane, as described above. Examples of a fabric having glossiness include a fabric woven by twill weave or satin weave. This is because a fabric woven by twill weave or satin weave exhibits glossiness due to a large number of warps appearing on the surface as compared with a fabric woven by plain weave.

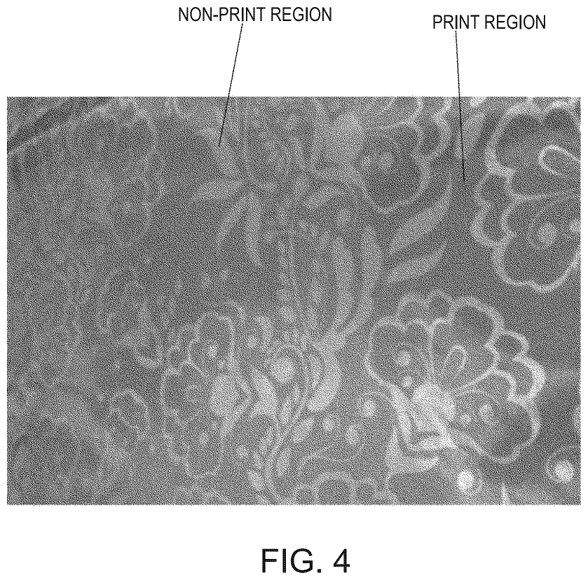

FIG. 4 illustrates a printed product obtained by forming an image on the medium S in the jacquard print mode. The medium S was acetate satin obtained by satin weaving acetate fibers. Acetate satin is a fabric having glossiness. The amount of overcoat liquid used was 6.6 g/m² in the print region. After printing, the medium S was dried at 160° C. for 2 minutes in order to remove moisture from the overcoat liquid. As a result, as shown in FIG. 4, the print region to which the overcoat liquid was applied was slightly darker than the non-print region to which the overcoat liquid was not applied. In other words, the print region exhibited a darker texture compared to the non-print region. It is considered that this is because a film made of a resin is formed in the print region, and thus the fabric itself exhibits a transparent texture. As described above, according to the jacquard print mode, it is possible to obtain a printed product having a visual effect close to the jacquard weave, that is, a visual effect in which the texture is partially different while the color of the fabric itself remains as it is.

Depending on the angle at which the medium S after printing illustrated in FIG. 4 is observed, a difference in texture between the print region and the non-print region appears or does not appear. Specifically, when the medium S after printing was observed along the normal line direction of the medium S, there was no difference in texture between the print region and the non-print region, and the image formed on the medium S in the jacquard print mode could not be recognized. On the other hand, in a case where the medium S after printing is observed from an oblique angle of 30 degree to 60 degrees with respect to the surface of the medium S, a clear difference in texture between the print region and the non-print region is generated, and thus it is possible to clearly recognize the image formed on the medium S in the jacquard print mode. In this way, since the image formed on the medium S appears or disappears depending on the angle at which the medium S after printing is observed, it is possible to realize a unique design property which is not provided in the jacquard weave.

Note that when the print product is spread over a white medium as a background, an image drawn on the print product is not visible. This is considered to be because the absence of a white object behind the print product is required as a precondition for the causal relationship that the transparent texture unique to the print region causes the print region to appear dark.

When a colorless liquid containing no resin particles is applied to a fabric having glossiness, a certain difference in texture could be produced between the print region and the non-print region. However, since a non-colored liquid that does not include the resin particles cannot form any film on the medium S, it is not possible to obtain the difference in texture as much as the print product illustrated in FIG. 4.

From the above consideration, the characteristics of the visual effect that can be achieved by the jacquard print mode are as follows.

(1) When the medium S after printing is observed from an oblique angle of 30 degrees to 60 degrees with respect to the surface of the medium S, there is a difference in texture between the print region and the non-print region.

(2) When the medium S after printing is observed along the normal line direction of the medium S, there is no difference in texture between the print region and the non-print region.

(3) When the printed product is spread out over a white medium background, the image formed on the printed product cannot be seen.

The amount of the overcoat liquid used in the jacquard print mode is 6.6 g/m² on the print region, but is not limited thereto, and can be appropriately selected between 1.0 g/m² and 15.0 g/m², preferably between 3.0 g/m² and 10.0 g/m², and more preferably between 5.0 g/m² and 8.0 g/m².

The heating temperature of the medium S in the drying process after printing is not limited to 160° C. The heating temperature can be appropriately selected between 80° C. and 250° C., preferably between 100° C. and 200° C., and more preferably between 130° C. and 180° C. Similarly, the heating time of the medium S in the drying process after printing is not limited to the illustrated two minutes. The heating time can be appropriately selected between 1 minute and 5 minutes, preferably between 1.5 minutes and 2.5 minutes, and more preferably between 1.8 minutes and 2.2 minutes.

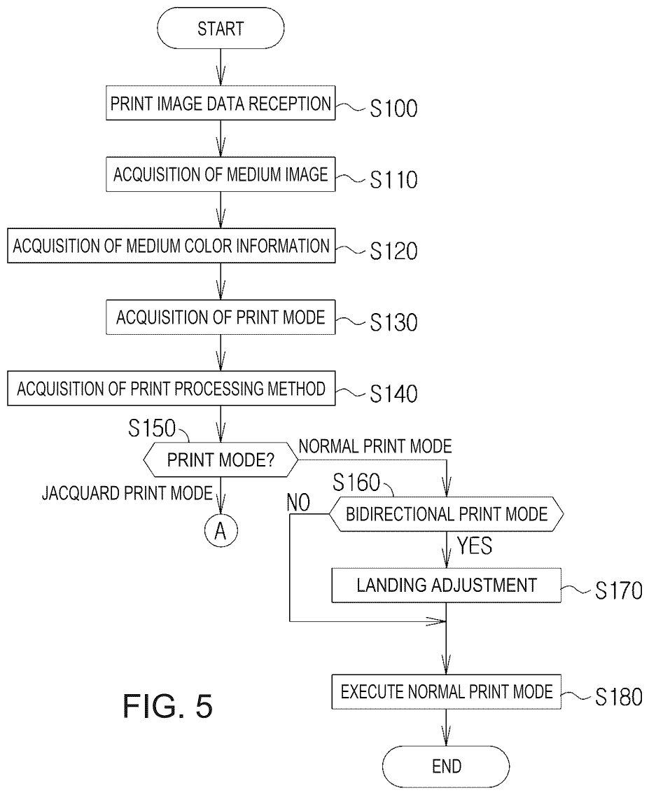

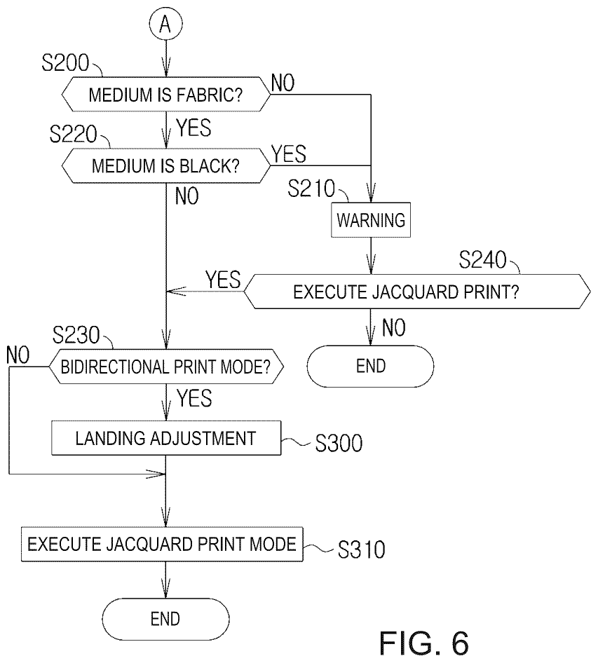

Next, an operation flow of the printing device 1 will be described with reference to FIGS. 5 and 6.

First, the control unit 4 receives the print image data (S100). The print image data is typically data indicating a print image created by a user using an application installed in a personal computer.

Next, the control unit 4 acquires the type of information of the medium S input by the user via the touch panel 71 (S110).

Next, the control unit 4 acquires the color information of the medium S input by the user via the touch panel 71 (S120). At this time, the control unit 4 may measure and acquire the color information of the medium S using a colorimeter, or the control unit 4 may measure and acquire the color information of the medium S using a two-dimensional camera.

Next, the control unit 4 displays a screen for selecting one of the normal print modes and the jacquard print mode as the print mode on the display 70 and acquires the print mode selected by the user via the touch panel 71 (S130).

Next, the control unit 4 displays a screen on the display 70 for selecting either the bidirectional printing method or the unidirectional printing method as the printing process and acquires the printing process selected by the user via the touch panel 71 (S140).

Next, in step S150, when the print mode acquired in step S130 is the normal print mode, the control unit 4 advances the process to step S160. In step S160, when the print processing method acquired in step S140 is the bidirectional printing method (S160: YES), the control unit 4 executes ink landing adjustment (S170). Then, the control unit 4 forms a print image indicated by the print image data on the medium S by executing the normal print mode (S180) and ends the process.

In step S150, when the print mode acquired in step S130 is the jacquard print mode, the control unit 4 advances the process to step S200 in FIG. 6. In step S200, the control unit 4 determines whether the medium S on which the image is formed in the jacquard print mode is fabric based on the information of type of the medium S acquired in step S110 (S200). If the medium S is not fabric (S200: NO), the control unit 4 advances the process to step S210. On the other hand, if the medium S is fabric (S200: YES), the control unit 4 advances the process to step S220. In step S220, the control unit 4 determines whether the medium S on which an image is to be formed in the jacquard print mode is black, based on the color information of the medium S acquired in step S120 (S220). If the medium S is black (S220: YES), the control unit 4 advances the process to step S210. On the other hand, if the medium S is not black (S220: NO), the control unit 4 advances the process to step S230.

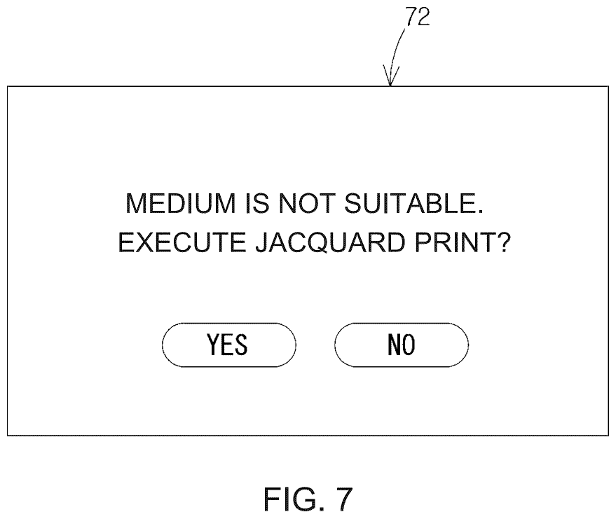

In step S210, the control unit 4 displays a warning screen 72 (shown in FIG. 7) on the display 70. That is, in the jacquard print mode, it is assumed that the medium S is a fabric, and the medium S is not black. This is because, in a case where the medium S is not fabric or in a case where the medium S is black, it is difficult for the visual effect unique to the jacquard print mode to be exhibited. Therefore, as shown in FIG. 7, on the warning screen 72, it is pointed out that the medium S is not suitable for the jacquard print mode, and the user is asked whether or not the jacquard print mode is to be executed. In step S240, when the user selects execution of the jacquard print mode (S240: YES), the control unit 4 advances the process to step S230. On the other hand, when the user selects not to execute the jacquard print mode in step S240 (S240: NO), the control unit 4 ends the process.

In step S230, when the print processing method acquired in step S140 is the bidirectional printing method (S230: YES), the control unit 4 executes landing (S300), and advances the processing to step S310. In detail, for example, the control unit 4 forms a test pattern on the medium S in the forward path and the return path by ejecting the colored ink from the nozzle row Lb of the head chip Hc1 of the liquid ejection head H1 illustrated in FIG. 3, and performs the landing adjustment based on the printing result of the test pattern formed in the forward path and the printing result of the test pattern formed in the return path. On the other hand, in step S230, when the print processing method acquired in Step S140 is not the bidirectional printing method (S230: NO), the control unit 4 advances the processing to step S310.

Then, the control unit 4 forms the print image indicated by the print image data on the medium S by executing the jacquard print mode and ends the process. The print image data suitable for the jacquard print mode is typically, for example, a binary image in which each pixel is expressed in white or black. Then, as an example, the control unit 4 applies the overcoat liquid to the print region corresponding to the black pixel of the medium S and does not apply any liquid to the non-print region corresponding to the white pixel.

The preferred embodiments of the present disclosure have been described above. The above embodiment has the following features.

The printing device 1 includes a head unit U (print head unit) having a nozzle row L (first nozzle group) formed of a plurality of nozzles 21 capable of ejecting the first liquid onto the medium S, and a control unit 4 (control section) that controls the ejection operation of the head unit U. The first liquid is a colorless liquid containing resin particles and water. When the medium S is a fabric having an uneven shape in which fibers in different directions intersect each other, the control unit 4 can execute a jacquard print mode (first print mode) in which the first liquid is ejected from the nozzle row L to form an image on the medium S. According to the above-described configuration, it is possible to obtain a printed product having a visual effect close to the jacquard weave with a simple configuration equivalent to a digital textile printing machine. Of course, since it is intended to obtain a printed product exhibiting a visual effect, the image formed using the first liquid in the first print mode is assumed to express a pattern or a design.

The first liquid is a liquid other than the UV-curable ink. The first liquid is a liquid that does not contain a photo polymerization initiator. According to the above configuration, the problem of odor caused by the uncured component can be solved.

The content of the resin particles is 80% or more by mass with respect to the total amount of the nonvolatile components in the composition of the first liquid. The resin particles contained in the first liquid are anionic resin particles. An example of this type of first liquid is the overcoat liquid described above. In the printing device 1, examples of the colorless liquid include a reaction liquid containing a coagulant agent and a treatment liquid containing a softening agent, in addition to the overcoat liquid. However, even when the reaction liquid or the softening agent was applied to the medium S, a visual effect close to the jacquard weave was not obtained. On the other hand, it is considered that the first liquid is suitable for obtaining a visual effect close to the jacquard weave.

The fabric as the medium S has glossiness. That is, in a case where the jacquard print mode is executed on a fabric having no glossiness, a difference in texture between the print region and the non-print region does not appear. Therefore, according to the above configuration, it is possible to obtain a visual effect close to the jacquard weave unique to the jacquard print mode.

The printing device 1 further includes a second nozzle group comprising a plurality of nozzles capable of ejecting a second liquid which is a colored liquid. As shown in FIG. 3, the first nozzle group and the second nozzle group are arranged on the same chip. Refer to the nozzle row La and the nozzle row Lb of the head chip Hc1 of the liquid ejection head H1. According to the above-described configuration, since the unit of the head chip Hc is assembled to the liquid ejection head H as a unit, even if there is an attachment error of the chip to the head, the landing error amount of the first nozzle group and the landing error amount of the second nozzle group are substantially equal to each other. In general, even when a test pattern is formed with a transparent liquid, it is difficult to visually check the landing result or to mechanically detect the landing result. Therefore, by arranging the nozzle row with the colored second liquid in the same chip as the transparent first liquid, it is possible to execute landing adjustment of the first liquid using the second liquid.

In particular, when a transparent liquid is used for the purpose of an overcoat for covering a color image or the like, high-precision landing adjustment of the first liquid is not required. However, since the image is formed mainly using the transparent liquid in the jacquard print mode described above, highly accurate landing adjustment of the first liquid is required. From such a viewpoint, it is desirable that the nozzle 21 capable of ejecting the first liquid and the nozzle 21 capable of ejecting the second liquid are arranged in the same chip. This is because, by performing landing adjustment using the second liquid, the landing error of the first liquid can be kept within the dimensional tolerance between the nozzle 21 capable of ejecting the first liquid and the nozzle 21 capable of ejecting the second liquid in the same head chip Hc.

Instead of the above, although the first nozzle group and the second nozzle group are mounted on different head chips Hc, they are preferably arranged on the same liquid ejection head H. According to the above-described configuration, by performing landing adjustment using the second liquid, the landing error of the first liquid can be kept within the dimensional tolerance between the nozzle 21 capable of ejecting the first liquid and the nozzle 21 capable of ejecting the second liquid in the same liquid ejection head H.

If the medium S is black, the control unit 4 issues a warning before executing the jacquard print mode. That is, it has been verified that even when the jacquard print mode is executed on the black medium S, a visual effect close to the jacquard weave is unlikely to be exhibited. Therefore, in a case where the medium S is black, it is possible to avoid wasteful consumption of the medium S or ink by issuing a warning before executing the jacquard print mode.

When the jacquard print mode is executed, the control unit 4 forms an image on the medium S without using the colored liquid. According to the above-described configuration, since the medium S is not colored, it is possible to realize a printed product in which a visual effect close to a jacquard weave is obtained.

Hereinafter, the overcoat liquid will be described in detail. In the following description, the overcoat liquid is referred to as a coating liquid composition. The coating liquid composition contains anionic resin particles and water. The anionic resin particles are a specific example of the resin particles. The content of the anionic resin particles is 80% or more by mass with respect to the total amount of the nonvolatile components in the coating liquid composition.

### Anionic Resin Particles

The coating liquid composition contains anionic resin particles. The resin particles can improve, for example, the adhesiveness of an image formed with the composition attached to a fabric. Examples of the anionic resin particles include an urethane-based resin, an acrylic-based resin (including a styrene-acrylic based resin), a fluorene-based resin, a polyolefin-based resin, a rosin-modified resin, a terpene-based resin, a polyester-based resin, a polyamide-based resin, an epoxy-based resin, a vinyl chloride based resin, a vinyl chloride-vinyl acetate copolymer, an ethylene-vinyl acetate based resin, or resin particles made of a silicone-acrylic based resin or the like that has an anionic character. Among these, a urethane-based resin, a silicone-acrylic based resin, an acrylic-based resin, a polyolefin-based resin, and a polyester-based resin are preferable. These resin particles are often handled in emulsion form but may also be in the property of a powder. The resin particles may be used singly or in combination of two or more kinds thereof.

The urethane-based resin is a general term for a resin having a urethane bond. As the urethane-based resin, in addition to the urethane bond, a polyether-type urethane resin containing an ether bond in the main chain, a polyester-type urethane resin containing an ester bond in the main chain, a polycarbonate-type urethane resin containing a carbonate bond in the main chain, or the like may be used. Commercially available products may be used as the urethane-based resins, and examples thereof include SUPERFLEX 460, 460s, 840, and E-4000 (trade names, manufactured by Dai-ichi Kogyo Seiyaku Co., Ltd), RESAMINE D-1060, D-2020, D-4080, D-4200, D-6300, and D-6455 (trade names, manufactured by Dainichiseika Color & Chemicals Mfg. Co., Ltd), TAKELAC WS-6021 and W-512-A-6 (trade names, manufactured by Mitsui Chemicals, Inc), SANCURE 2710 (trade name, manufactured by Lubrizol Corporation), PERMARIN UA-150 (trade name, manufactured by Sanyo Chemical Industries, Ltd), and ETERNACOLLUW series such as UW-1527 (manufactured by Ube Industries, Ltd).

The acrylic-based resin is a general term for a polymer obtained by polymerizing at least an acrylic monomer such as (meth) acrylic acid or a (meth) acrylic acid ester as one component, and examples thereof include a resin obtained from an acrylic monomer, and a copolymer of an acrylic monomer and another monomer. For example, an acryl-vinyl-based resin which is a copolymer of an acryl-based monomer, and a vinyl-based monomer may be mentioned. Examples of the vinyl-based monomer include styrene.

As the acrylic-based monomer, an acrylamide, an acrylonitrile and the like can also be used. The acrylic-based resin emulsion may be selected from commercially available products may be used, for example, FK-854 (trade name, Chuo Rika Kogyo Co., Ltd), MOWINYL 952B, 718A, 6760 (trade name, Japan Coating Resin Co., Ltd) Nipol LX852, LX874 (trade name, Zeon Corporation).

In the present specification, the acrylic-based resin may be a styrene-acrylic based resin which will be described later. In the present specification, the expression “(meth) acrylic” means at least one of acrylic and methacrylic.

A styrene-acrylic based resins are copolymers obtained from styrene monomers and (meth) acrylic based monomers, and examples thereof include styrene-acrylic acid copolymers, a styrene-methacrylic acid copolymers, a styrene-methacrylic acid-acrylic acid ester copolymers, styrene-α-methyl styrene-acrylic acid copolymers, and styrene-α-methyl styrene-acrylic acid-acrylic acid ester copolymers. As the styrene-acrylic based resin, commercially available products may be used, and for example, JONCRYL 62J, 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, 7610 (trade names, manufactured by BASF Corporation), MOWINYL 966A, 975N (trade names, Japan Coating Resin Co., Ltd), VINYBLAN 2586 (trade names, manufactured by Nissin Chemical Industry Co., Ltd), and the like may be used.

As the silicone-acrylic copolymer resin, a commercially available product can be used. For example, the CHALINE series FE-230N, FE-502, E-370, RU-911, R-170, R170S, LC-190, R-170BX (trade names, manufactured by Nissin Chemical Industry Co., Ltd), SYMAC US-380, SYMAC US-450, SYMAC US-480 (trade names, manufactured by TOAGOSEI Co., Ltd), IE-7170, SE1980CLEAR, BY22-826EX, PROPYLENEOXY LON-MF-40 (trade names, manufactured by Dow Corning Toray Co., Ltd), LEXAN EXL (trade names, manufactured by SABIC Innovative Plastics Japan LLC), TARFLON NEO (trade name, manufactured by Idemitsu Kosan Co), BANSTER S-806 (trade name, manufactured by Saiden Chemical Industry Co., Ltd), MOWINYL (trade name, manufactured by Nippon Gohsei Co., Ltd), COATAX (trade name, manufactured by Toray Industries Co, Ltd), DAITOSOL 5000SJ (trade name, manufactured by DAITO KASEI KOGYO CO., LTD.), YODOSOLE GH41 (trade name, manufactured by Henkel Japan Co., Ltd), Acrylates/ethylhexyl acrylate/dimethicone methacrylate COPOLYMER (trade name: KP578) manufactured by Shin-Etsu Chemical Co., Ltd.), VONCOAT, CERANATE (trade name, manufactured by DIC Co., Ltd.), acrylic silicone-based emulsion SIFCLEARS101, SIFCLEARS102 (manufactured by JSR) and the like may be mentioned.

The polyolefin-based resins have a structural skeleton based on olefins such as ethylene, propylene, and butylene, and known types can be appropriately selected and used. As the olefin resin, a commercially available product can be used, and for example, ARROWBASE CB-1200 and CD-1200 (trade names, manufactured by UNITIKA Ltd) may be used.

The resin particles may be supplied as emulsion forms. Examples of such commercially available resin emulsions include, Microgel E-1002, e-5002 (trade name, manufactured by Nippon Paint Co., Ltd), styrene-acrylic-based resin emulsion), VONCOAT 4001 (trade name, manufactured by DIC Corporation, acrylic-based resin emulsion), VONCOAT (trade name, manufactured by DIC 5454 Corporation, styrene-acrylic resin emulsion), POLYSOL AM-710, AM-920, AM-2300, AP-4735, AT-860, PSASE-4210E (acrylic resin emulsion), POLYSOL AP-7020 (styrene-acrylic resin emulsion), POLYSOL SH-502 (vinyl acetate resin emulsion), POLYSOL AD-13, AD-2, AD-10, AD-96, AD-17, AD-70 (ethylene-vinyl acetate resin emulsion), POLYSOL PSASE 6010 (ethylene-vinyl acetate emulsion, trade name, manufactured by Resonac Co.), POLYSOL SAE1014 (trade name, styrene-acrylic-based resin emulsion, manufactured by Zeon Corporation), Cybinol SK-200 (trade name, acrylic-based resin emulsion, Saiden Chemical Industry Co., Ltd), AE-120A (trade name, manufactured by JSR Corporation, acrylic resin emulsion), AE373D (trade name, manufactured by E-Tek Co, carboxy-modified styrene-acrylic resin emulsion), SEIKADYNE 1900W (trade name, manufactured by Dainichiseika Color & Chemicals Mfg. Co., Ltd., ethylene-vinyl acetate resin emulsion), VINYBLAN 2682 (acrylic resin emulsion), VINYBLAN 2886 (vinyl acetate-acrylic resin emulsion), VINYBLAN 5202 (acetic acid acrylic resin emulsion, trade name, manufactured by Nissin Chemical Industry Co., Ltd), elitel KA-5071S, KT-8803, KT-9204, KT-8701, KT-8904, KT-0507 (trade name, manufactured by Unitika Ltd, polyester resin emulsion), HITEC SN-2002 (trade name, manufactured by Toho Chemical Industry Co., Ltd, polyester resin emulsion), TAKELAC W-6020, W-635, W-6061, W-605, W-635, W-6021, WS-5100 (trade name, manufactured by Mitsui Chemicals, Inc, urethane-based resin emulsion), SUPERFLEX 870, 800, 150, 420, 460, 470, 610, 700 (trade name, manufactured by Dai-ichi Kogyo Seiyaku Co, urethane-based resin emulsion), PERMARIN UA-150 (manufactured by Sanyo Chemical Industries, Ltd, urethane-based resin emulsion), SANCURE 2710 (manufactured by Lubrizol Corporation, Japan, urethane-based resin emulsion), NeoRez R-9660, R-9637, R-940 (manufactured by Kusumoto Chemicals, Ltd, urethane-based resin emulsion), ADEKA BONTIGHTER HUX-380, 290K (manufactured by ADEKA Corporation, urethane-based resin emulsion), MOWINYL 966A, MOWINYL 7320 (manufactured by Japan Coating Resin Co., Ltd), JONCRYL 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, 7610, (manufactured by BASF), NK binder R-5HN (manufactured by Shin-Nakamura Chemical Co., Ltd), HYDRAN WLS-210 (non-crosslinkable polyurethane, manufactured by DIC Corporation), JONCRYL 7610 (manufactured by BASF) or the like.

The content of the resin particles in the coating liquid composition is 80% or more by mass with respect to the total amount of the nonvolatile components. The content of the resin particles in the coating liquid composition is more preferably 83% or more by mass and even more preferably 90% or more by mass with respect to the total amount of the nonvolatile components.

### Water

The coating liquid composition contains water. Examples of the water include pure water such as ion exchange water, ultrafiltration water, reverse osmosis water, and distilled water, and water from which ionic impurities are removed as much as possible, such as ultrapure water. When water sterilized by ultraviolet irradiation, addition of hydrogen peroxide, or the like is used, generation of bacteria and fungi can be reduced when the composition is stored for a long period of time.

The content of water is 30% or more by mass with respect to the total amount of the coating liquid composition, preferably 40% or more by mass, more preferably 45% or more by mass, and even more preferably 50% or more by mass. When the content of water is 30% or more by mass, the coating liquid composition can have a relatively low viscosity. The upper limit of the content of water is preferably 90% by mass or less, more preferably 858 by mass or less, and even more preferably 80% by mass or less with respect to the total amount of the coating liquid composition.

### Other Components

The coating liquid composition may contain a water-soluble resin, a moisturizing agent, another solvent, an additive agent, a surfactant, and the like in addition to the anionic resin particles and water.

The coating liquid composition may contain a water-soluble resin. The water-soluble resin is not particularly limited, and examples thereof include carboxymethyl cellulose, hydroxyethyl cellulose, polyvinylpyrrolidone, and polyethylene oxide. Among these, a nonionic resin is more preferable, and for example, polyvinylpyrrolidone is more preferable. The polyvinylpyrrolidone is not limited to a homopolymer, and a copolymer of vinylpyrrolidone and another monomer may be used. Examples of commercially available products of polyvinylpyrrolidone include Polyvinylpyrrolidone K-30, k-30W (trade names, manufactured by Nippon Shokubai Co., Ltd), PITZCOL® K-17L, K-30, K-30L, K-30AL, K-60L, K-30, K-50, K-90, CREEJUS® K-30, AIPHTACT® K-30PH (product name, manufactured by Dai-ichi Kogyo Seiyaku Co., Ltd), PVP K-30, PVP K-25, PVP K-17 (product name, manufactured by Ashland Inc.).

The coating liquid composition may contain a moisturizing agent. The moisturizing agent is not particularly limited, and examples thereof include glycerin; 2-pyrrodrine; carbamide; triethanolamine; propylene glycol; 1-(2-hydroxyethyl)-2-pyrrodrine; trimethylolpropane; triethylene glycol; 1,5-pentanediol; triethylene glycol monomethyl ether, amino coat or the like. Among these, one type can be used alone, or two or more types can be used in combination.

The coating liquid composition may contain other solvents. The other solvent is preferably a water-soluble organic solvent. One of the functions of the organic solvent is to improve the wettability of the coating liquid composition with respect to the fabric or to increase the moisture retention of the coating liquid composition. The organic solvent can also function as a penetrant.

Examples of the organic solvent include esters, alkylene glycol ethers, cyclic esters, nitrogen-containing solvents, and polyhydric alcohols. Examples of the nitrogen-containing solvent include cyclic amides and non-cyclic amides. Examples of the non-cyclic amides include alkoxyalkylamides.

Examples of the esters include a glycol monoacetate such as an ethylene glycol monomethyl ether acetate, an ethylene glycol monoethyl ether acetate, and an ethylene glycol monobutyl ether acetate; and a glycol diester such as an ethylene glycol diacetate, a diethylene glycol diacetate, and a propylene glycol diacetate.

The alkylene glycol ethers may be monoether or diether of alkylene glycol and is preferably alkyl ether. Specific examples thereof include ethylene glycol monomethyl ether, ethylene glycol monoethyl ether, ethylene glycol monoisopropyl ether, ethylene glycol monobutyl ether, alkylene glycol monoalkyl ethers such as diethylene glycol monomethyl ether, and alkylene glycol dialkyl ethers such as ethylene glycol dimethyl ether, ethylene glycol diethyl ether, ethylene glycol dibutyl ether, diethylene glycol dimethyl ether, diethylene glycol diethyl ether.

Examples of the cyclic esters include cyclic esters (lactones) such as β-propiolactone, γ-butyrolactone, δ-valerolactone, ε-caprolactone, and β-butyrolactone, and compounds obtained by substituting hydrogens of methylene groups adjacent to carbonyl groups of the cyclic esters with alkyl groups having 1 to 4 carbon atoms.

Examples of the alkoxyalkylamides include 3-methoxy-N, N-dimethylpropionamide, 3-methoxy-N, N-diethylpropionamide, 3-methoxy-N, N-methylethylpropionamide, 3-ethoxy-N, N-dimethylpropionamide, 3-ethoxy-N, N-diethylpropionamide, 3-ethoxy-N, N-methylethylpropionamide, 3-N-butoxy-N, N-dimethylpropionamide, 3-N-butoxy-N, N-diethylpropionamide, and 3-N-butoxy-N, N-methylethylpropionamide.

Examples of the cyclic amides include lactams, and examples thereof include pyrrolidones such as a 2-pyrrolidone, a 1-methyl-2-pyrrolidone, a 1-ethyl-2-pyrrolidone, a 1-propyl-2-pyrrolidone, and a 1-butyl-2-pyrrolidone.

As the alkoxyalkylamide, a compound represented by the following general formula (1) is also preferably used.

R¹—O—CH₂CH₂—(C═O)—NR²R³ (1)

In the formula (1), R¹ represents alkyl groups having 1 to 4 carbon atoms, and R² and R³ each independently represent methyl groups or ethyl groups. The “alkyl group having 1 to 4 carbon atoms” may be a linear or branched alkyl group, and may be, for example, methyl group, ethyl group, N-propyl group, iso-propyl group, N-butyl group, sec-butyl group, iso-butyl group, or tert-butyl group. The compound represented by the formula (1) may be used alone or in combination of two or more kinds thereof.

Examples of polyhydric alcohols include 1,2-alkanediols (such as ethylene glycol, propylene glycol (also known as propane-1,2-diol), 1,2-butanediol, 1,2-pentanediol, 1,2-hexanediol, 1,2-heptanediol, 1,2-octanediol, and other alkanediols), and polyhydric alcohols excluding 1,2-alkanediols (that is polyols such as diethylene glycol, dipropylene glycol, 1,3-propanediol, 1,3-butanediol (also known as 1,3-butylene glycol), 1,4-butanediol, 1,5-pentanediol, 1,6-hexanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, trimethylolpropane, glycerin, and others). Examples of the polyhydric alcohols include alkanediols and polyols. Alkanediols are diols of alkanes having 5 or more carbon atoms. The number of carbon atoms of the alkane is preferably 5 to 15, more preferably 6 to 10, and still more preferably 6 to 8. Preferred is 1,2-alkanediol.

The polyol is a polyol of an alkane having 4 or less carbon atoms or an intermolecular condensate of hydroxyl groups of polyols of alkanes having 4 or less carbon atoms. The carbon number of the alkane is preferably 2 to 3. The number of hydroxyl groups in the molecule of the polyol is 2 or more, preferably 5 or less, and more preferably 3 or less. When the polyol is the intermolecular number 41 intermolecular condensate, the of condensations is 2 or more, preferably 4 or less, and more preferably 3 or less. The polyhydric alcohols may be used alone or in combination of two or more.

Alkanediols and polyols can function mainly as penetrating solvent and/or moisturizing solvent. However, alkanediols tend to have a strong property as penetrating solvent, and polyols tend to have a strong property as moisturizing solvent.

The coating liquid composition may contain an additive agent. Examples of the additive agents include pH adjuster, saccharide, chelating agent, preservative/fungicide, rust inhibitor, and the like.

The pH adjuster is not particularly limited, and examples thereof include an appropriate combination of an acid, a base, a weak acid, and a weak base. Examples of acids and bases used in such combinations include inorganic acids such as sulfuric acid, hydrochloric acid, and nitric acid; inorganic bases such as lithium hydroxide, sodium hydroxide, potassium hydroxide, potassium dihydrogen phosphate, disodium hydrogen phosphate, potassium carbonate, sodium carbonate, sodium bicarbonate, and ammonia, and organic bases such as triethanolamine, diethanolamine, monoethanolamine, tripropanolamine, triisopropanolamine, diisopropanolamine, and tris(hydroxymethyl)aminomethane (THAM). Additionally, organic acids such as adipic acid, citric acid, succinic acid, lactic acid, N, N-bis(2-hydroxyethyl)-2-aminoethanesulfonic acid (BES), 4-(2-hydroxyethyl)-1-piperazineethanesulfonic acid (HEPES), morpholinoethanesulfonic acid (MES), carbamoylmethyliminodiacetic acid (ADA), piperazine-1,4-bis(2-ethanesulfonic acid) (PIPES), N-(2-acetamido)-2-aminoethanesulfonic acid (ACES), colamine hydrochloride, N-tris(hydroxymethyl)methyl-2-aminoethanesulfonic acid (TES), acetamidoglycine, tricine, glycinamide, bicine, and other Good's buffers, as well as phosphate buffer liquid, citrate buffer liquid, and tris buffer liquid, can also be used. Further, among these, it is preferable that tertiary amine such as triethanolamine or triisopropanolamine and carboxyl group-containing organic acid such as adipic acid, citric acid, succinic acid, or lactic acid are contained as a part or all of the pH adjusting agent, since the pH buffering effect can be more stably obtained.

Specific examples of the saccharide include glucose, mannose, fructose, ribose, xylose, arabinose, galactose, aldonic acid, glucitol (sorbit), maltose, cellobiose, lactose, sucrose, trehalose, and maltotriose.

Examples of the chelating agent include ethylenediaminetetraacetic acid and salts thereof (ethylenediaminetetraacetic acid dihydrogen disodium salt, nitrilotriacetic acid salt of ethylenediamine, hexametaphosphate salt, pyrophosphate salt, metaphosphate salt, or the like).

Examples of the antiseptic and the fungicide include sodium benzoate, sodium pentachlorophenol, sodium 2-pyridinethiol-1-oxide, sodium sorbate, sodium dehydroacetate, PROXEL CRL, PROXEL BDN, PROXEL GXL, PROXEL XL-2, PROXEL IB, and PROXEL TN (trade name, manufactured by Arxada JAPAN Ltd, Co.), 4-chloro-3-methylphenol (e.g., PREVENTOL CMK, manufactured LANXESS Deutschland GmbH), and the like.

Examples of the rust inhibitor include benzotriazole, acidic sulfite salt, sodium thiosulfate, ammonium thioglycolate acid, diisopropylammonium nitrite, pentaerythritol tetranitrate, and dicyclohexylammonium nitrite. Among these, benzotriazole is particularly preferable.

Examples of the other additives agent include a viscosity modifier agent, an antifungi agent, an antioxidant agent, an oxygen absorber agent, and a dissolution aid agent.

The coating liquid composition may contain a surfactant. The surfactant has a function of adjusting the surface tension of the composition and adjusting, for example, wettability with a fabric. Among the types of surfactants, for example, acetylene glycol-based surfactants, silicone-based surfactants, and fluorine-based surfactants are preferable.

The acetylene glycol-based surfactants are not particularly limited, and examples thereof include SURFYNOL 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, DF110D (all trade names, manufactured by Air Products and Chemicals, Inc.), OLFINE B, Y, P, A, STG, SPC, E1004, E1010, PD-001, PD-002W, PD-003, PD-004, EXP.4001, EXP.4036, EXP. 4051, AF-103, AF-104, AK-02, SK-14, AE-3 (all trade names, manufactured by Nissin Chemical Industry Co., Ltd.), ACETYLENOL E00, E00P, E40, E100 (all trade names, manufactured by Kawaken Fine Chemicals Co., Ltd).

The silicone-based surfactant is not particularly limited, but a polysiloxane-based compound is preferably exemplified. The polysiloxane-based compound is not particularly limited, and examples thereof include a polyether-modified organosiloxane. Examples of commercially available products of the polyether-modified organosiloxane include BYK-306, BYK-307, BYK-333, BYK-341, BYK-345, BYK-346, BYK 348 (all trade name, BYK-Chemie Japan KK), KF-351A, KF-352A, KF-353, KF-354L, KF-355A, KF-615A, KF-945, KF-640, KF-642, KF-643, KF-6020, X-22-4515, KF-6011, KF-6012, KF-6015, KF-6017 (all trade name Shin-Etsu Chemical Co., Ltd), SILFACE SAG002, 005, 503A, 008 (all trade name, manufactured by Nissin Chemical Industry Co., Ltd.).

As the fluoro-based a fluorine-modified polymer is preferably used, and specific examples thereof include BYK-3440 (manufactured by BYK-Chemie Japan KK), SURFLON S-241, SURFLON S-242, and SURFLON S-243 (all trade names, manufactured by AGC Seimi Chemical Co., Ltd), and FTERGENT 215M (manufactured by Neos Co., Ltd).

When a surfactant is contained in the coating liquid composition, a plurality of surfactants agent may be contained. When the surfactant is contained in the coating liquid composition, the content thereof can be set to 0.1% or more by mass and 2% by mass or less, preferably 0.3% or more by mass and 1.5% by mass or less, and more preferably 0.4% or more by mass and 1.0% by mass or less with respect to the total mass of the coating liquid composition.

In the coating liquid composition, the content of the coloring material is preferably 0.1% by mass or less with respect to the total amount of the coating liquid composition. That is, it is preferable that the coating liquid composition is not used with the intention of coloring.

### Manufacturing and Physical Properties

The viscosity of the coating liquid composition at 20° C. on the storage medium ejected by inkjet method is preferably 1.5 mPa's or more and 15 mPa's or less, more preferably 1.5 mPa·s or more and 7 mPa·s or less, and still more preferably 1.5 mPa·s or more and 5.5 mPa·s or less.

The surface tension of the coating liquid composition at 25° C. is 40 mN/m or less, preferably 38 mN/m or less, more preferably 35 mN/m or less, and even more preferably 30 mN/m or less, from the viewpoint of appropriate wettability and spreadability of the coating liquid composition to coat on the storage medium. The surface tensions are preferably 20 mN/m or more, and more preferably 25 mN/m or more.

The surface tension can be measured by confirming the surface tension when a platinum plate is wetted with the composition under an environment of 25° C. using an automatic surface tensiometer CBVP-Z (manufactured by Kyowa Interface Science Co., Ltd).

The coating liquid composition is obtained by mixing the above-described components in an arbitrary order and removing impurities by filtration or the like as necessary. As a mixing method of each component, a method of sequentially adding materials to a container provided with a stirring device such as a mechanical stirrer, a magnetic stirrer, or the like, and stirring and mixing the materials is suitably used. As a filtration method, centrifugal filtration, filter filtration, or the like can be performed as necessary.

The adhesion amount of the coating liquid composition in the adhesion region for the storage medium is preferably 1 g/m² or more and 15 g/m² or less, more preferably 2 g/m² or more and 10 g/m² or less, and still more preferably 5 g/m² or more and 8 g/m² or less. In this manner, an image effect similar to a jacquard weave can be exhibited, and the coating liquid composition can be prevented from bleeding. The adhesion amount of the coating liquid composition is also referred to as an implant amount of the coating liquid composition.

In the above-described examples, the program can be stored using various types of non-transitory computer readable medium (non-transitory computer readable medium) and supplied to the computer. Non-transitory computer-readable medium include various types of tangible storage medium (tangible storage medium). Examples of the non-transitory computer-readable medium include a magnetic storage medium (for example, a flexible disk, a magnetic tape, or a hard disk drive) and a magneto-optical storage medium (for example, a magneto-optical disk). Examples of non-transitory computer-readable medium further include CD-ROMS (Read Only Memory), Recordable Compact Disc, Rewritable Compact Disc, semiconductor memories (e.g., mask ROM), and the like. Examples of non-transitory computer-readable medium also include programmable ROMS (PROM), erasable PROM (EPROM), flash ROM, and random access memories (RAM). The program may be supplied to the computer by various types of the transitory computer-readable medium. Examples of transitory computer-readable medium include electric signals, light signals, and electromagnetic waves. The transitory computer-readable medium can supply the program to the computer via a wired communication path such as an electrical wire and an optical fiber, or a wireless communication path.

What is claimed is:

1. A printing device comprising:
a print head unit with a first nozzle group that has a plurality of nozzles and that ejects a first liquid onto a medium and
a control section configured to control an ejection operation of the print head unit; wherein
the first liquid is colorless liquid containing resin particles and water and
the control section is configured to, when the medium is fabric having an uneven shape in which fibers in different directions intersect each other, execute a first print mode in which an image is formed on the medium by ejecting the first liquid from the first nozzle group.

2. The printing device according to claim 1, wherein
the first liquid is a liquid other than UV-curable ink.

3. The printing device according to claim 1, wherein
content of the resin particles is 80% or more by mass with respect to the total amount of nonvolatile components in the composition of the first liquid and
the resin particles contained in the first liquid are anionic resin particles.

4. The printing device according to claim 1, wherein
the fabric has glossiness.

5. The printing device according to claim 4, wherein
fabric having glossiness is change in light reflection properties of the fabric depending on an angle at which the fabric is observed.

6. The printing device according to claim 4, wherein
the fabric having glossiness is a fabric woven with a synthetic fiber.

7. The printing device according to claim 4, wherein
the fabric having glossiness is a fabric woven by twill weave or satin weave.

8. The printing device according to claim 1, further comprising:
a second nozzle group including a plurality of nozzles configured to eject a second liquid, which is a colored liquid, wherein
the first nozzle group and the second nozzle group are arranged on the same chip.

9. The printing device according to claim 1, further comprising:
a second nozzle group including a plurality of nozzles configured to eject a second liquid, which is a colored liquid, wherein
the first nozzle group and the second nozzle group are arranged in the same head.

10. The printing device according to claim 1, wherein
when the medium is black, the control section issues a warning before executing the first print mode.

11. The printing device according to claim 1, wherein
the control section forms the image on the medium without using colored liquid in a case of executing the first print mode.

12. A printing method using a printing device including a print head unit having a first nozzle group including a plurality of nozzles capable of ejecting a first liquid, which is a colorless liquid containing resin particles and water to a medium, the printing method comprising:
when the medium is a fabric having an uneven shape in which fibers in different directions intersect, using a computer to execute a first print mode in which the first liquid is ejected from the first nozzle group to form an image on the medium.
